(19) United States
(12) Patent Application Publication
(10) Pub. No.: US 2020/0003562 A1
(43) Pub. Date: Jan. 2, 2020

(54) METHOD FOR OPERATING A MANEUVERING ASSISTANCE SYSTEM

(71) Applicant: Ford Global Technologies, LLC, Dearborn, MI (US)

(72) Inventors: Oliver Kirstein, Wermelskirchen/NRW (DE); Franziskus Bauer, Huerth/NRW (DE); Lukas Preusser, Cologne/NRW (DE)

(73) Assignee: Ford Global Technologies, LLC, Dearborn, MI (US)

(21) Appl. No.: 16/442,633

(22) Filed: Jun. 17, 2019

(30) Foreign Application Priority Data
Jun. 29, 2018 (DE) 102018210782.3

(51) Int. Cl. G01C 21/30; G01C 21/34

(52) U.S. Cl. CPC G01C 21/30; G01C 21/3664; G01C 21/3461

(57) ABSTRACT

The invention relates to a method for operating a maneuvering assistance system of a motor vehicle, having the steps of: reading in surroundings data of the motor vehicle representative of maneuvering spaces along a traveled stretch of road having a predetermined length, evaluating the read-in surroundings data in order to determine at least one suitable maneuvering space, and adding the maneuvering space to a map data record representative of the traveled stretch of road.

### CROSS-REFERENCE TO RELATED APPLICATION

This patent application claims priority to German Application No. DE 102018210782.3 filed on Jun. 29, 2018, which is hereby incorporated by reference in its entirety.

### BACKGROUND

Parking assistance systems can automatically park a motor vehicle in both parallel and perpendicular parking spaces. These systems assist the driver by selecting the correct steering angle themselves. Additionally, they can survey the parking space beforehand. The driver then only needs to operate the accelerator and brake pedals. Such parking assistance systems can be overridden by the driver at any instant. Besides this semiautomatic parking, the parking assistance system can also provide fully automatic parking. In this case, longitudinal movement is also actively controlled by the motor vehicle.

Typically a parking assistance system is activated by means of a switch, e.g. in the center console of the motor vehicle. Alternatively, the parking assistance system can also be activated in other ways. The driver then drives slowly alongside parked motor vehicles and the parking space. In this case, the parking assistance system scans both the right and the left side of the road for possible parallel and/or perpendicular parking spaces as it moves. The driver then selects the side of the road on which the driver wishes to park, e.g., by switching on the turn signal. If the parking space is long enough, this is indicated to the driver, e.g., in a display. The driver then drives to the indicated starting point and engages reverse gear. The parking assistance system becomes active and the automatic steering control undertakes parking. The driver still needs to pay attention to his surroundings, however, and take the motor vehicle into the parking space by carefully operating the accelerator pedal. The end of reversing is indicated, e.g., audibly. The driver is then instructed by further prompts, e.g., in a display to drive forward and, if need be, backward again. The number of parking moves is dependent on the length of the parking space.

Certain parking assistants are known e.g. from U.S. Pat. No. 9,807,352 B2, DE 10 2010 010 652 A1 or US 2014/0244095 A1. However, such systems offer no assistance for maneuvering during the search for a parking space, that is to say for maneuvers such as turning, reversing out of the way or other reversing maneuvers to get to a parking space.

### BRIEF SUMMARY

The present disclosure relates to operating a vehicle maneuvering assistance system offering assistance for maneuvering, i.e., turning, reversing out of the way or other reversing maneuvers.

A method for operating a maneuvering assistance system of a motor vehicle includes:
reading in surroundings data of the motor vehicle for maneuvering spaces along a traveled stretch of road having a predetermined length,
evaluating the read-in surroundings data in order to determine at least one suitable maneuvering space, and
adding the maneuvering space to a map data record representative of the traveled stretch of road.

Thus, surroundings data are captured and evaluated, including data as arising in the event of a search for a parking space using a conventional parking assistance system designed only for parking. The maneuvering spaces for turning, reversing out of the way, or other reversing maneuvers, which maneuvering spaces are thus detected by evaluating the surroundings data, are then added to a map data record or embedded into the map data record, so that an expanded map data record having the detected maneuvering spaces is provided. The expanded map data record can then be evaluated by a navigation system in order to determine a route of travel in which the maneuvering space is included.

According to one example, the map data record is presented by means of an HMI (human-machine interface). As such, the route of travel can be presented to the driver in a manner familiar to the driver from the navigation system. Additionally, there can be provision for voice outputs for assistance. If the motor vehicle is self-driving, on the other hand, that is to say, e.g., is a level 4 or level 5 motor vehicle, reproduction of the route of travel can be dispensed with.

According to a further example, a route of travel starting from the present position of the motor vehicle is determined by including the maneuvering space intended to be used for turning or getting out of the way, for example. The route of travel is then used to take the driver purposefully to the maneuvering space, and the driver is then instructed to use the maneuvering space for a maneuver, such as turning, reversing out of the way or other reversing maneuvers. This takes the burden off the driver and permits the driver to pay attention exclusively to the traffic, reducing the risk of accidents.

According to a further example, a plurality of maneuvering spaces are determined, and at least one of the plurality of maneuvering spaces is selected according to at least one predetermined criterion. The selectable criteria can be, e.g., a distance from the respective maneuvering spaces and/or their respective size and/or their suitability or accessibility, e.g., in terms of maneuvering complexity or the number of maneuvering moves required or driving over curves. Further criteria can be a distance from a destination, such as a destination stored in a navigation system, or a regularity or frequency with which a destination is headed for by the driver. Selection of the criterion is performed by the driver before and during activation of the maneuvering assistance system. One of the criteria may have been preselected at the factory, so that even without driver selection of a criterion one maneuvering space is selected when a plurality of maneuvering spaces have been detected.

According to a further example, the route of travel can be modified by a driver of the motor vehicle. This can be effected, e.g., by means of a touch display of a navigation system of the motor vehicle, e.g., by marking individual points on the presented route of travel and subsequently moving them. As such, the route of travel can be put into a form that the driver wants most.

According to a further example, the map data record is reproduced in the form of a 360° panoramic view. Therefore, the representation corresponds to a bird's eye view as in a surround view system, producing an image of the motor vehicle from above. To this end, image data for multiple cameras of the motor vehicle are digitally equalized and presented on the HMI.

According to a further example, the map data record is reproduced in a perspective representation or 3D representation or 360° view. The route of travel can be modified by the driver by using the touch-sensitive screen. The system of the reversing assistance system then calculates the back projection onto the map for the altered driving maneuver.

According to a further example, the map data record is reproduced in a perspective representation or 3D representation. The route of travel can be reproduced by a direction arrow inserted into the representation.

Further, the present subject matter includes a computer program product for performing such a method, a maneuvering assistance system and a motor vehicle having such a maneuvering assistance system.

### SUMMARY OF THE DRAWINGS

The disclosure will now be explained on the basis of a drawing, in which:

FIG. 1 is a schematic illustration showing a scenario in which a search for a parking space is assisted by a maneuvering assistance system.

FIG. 2 is a schematic illustration showing further details of the maneuvering assistance system.

FIG. 3a is a schematic illustration showing a graphical reproduction on an HMI.

FIG. 3b is a schematic illustration showing the graphical reproduction shown in FIG. 3a in a perspective representation on the HMI.

FIG. 4a is a schematic illustration showing a further graphical reproduction on the HMI.

FIG. 4b is a schematic illustration showing the graphical reproduction shown in FIG. 4a in a perspective representation on the HMI.

### DESCRIPTION

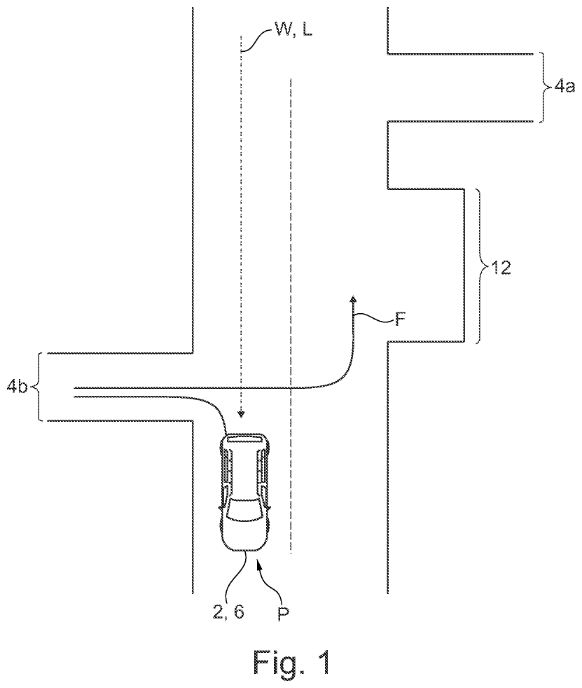

Reference is first of all made to FIG. 1, which depicts a scenario in which a driver of a motor vehicle 2 is looking for a parking space.

The motor vehicle 2 in the present example is an automobile equipped with a parking assistance system.

The parking assistance system is designed to automatically park the motor vehicle 2 in both parallel and/or perpendicular parking spaces. To this end, the parking assistance system selects the correct steering angle itself and also undertakes surveying of the parking space beforehand. The driver now only needs to operate the accelerator pedal and to brake.

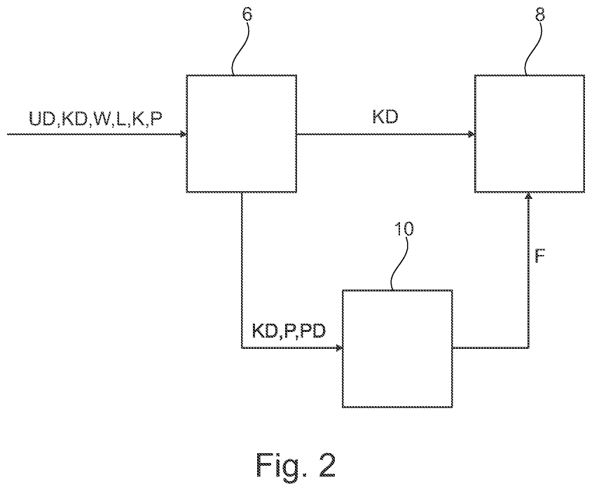

However, such a parking assistance system offers no assistance for maneuvering during the search for a parking space. To remedy this, a maneuvering assistance system 6 will now be explained with additional reference to FIG. 2.

The maneuvering assistance system 6 according to the present example is designed for data interchange with HMI 8 and a navigation system 10, as will be explained in more detail later. For the tasks and functions described below, the maneuvering assistance system 6, the HMI 8 and the navigation system 10 have hardware and/or software components.

The maneuvering assistance system 6 is thus designed to scan both the right and the left side of the road for possible parallel and/or perpendicular parking spaces as it travels past. To this end, the maneuvering assistance system 6 resorts to surroundings data UD provided by ambient sensors of the motor vehicle 2. The ambient sensors can be radar, ultrasonic or lidar sensors and/or can be cameras such as front and rear cameras.

In this case, the driver has driven the motor vehicle 2 on the road from top to bottom in the present example. In other words, the driver has taken the motor vehicle 2 first past the first maneuvering space 4a, then the parking space 12 and finally to a second maneuvering space 4b. The parking space 12 is on the opposite side of the road in this case and is in the form of a parallel parking space. Therefore, the parking space 12 in the present exemplary example can be reached only by means of a turning maneuver with the motor vehicle 2.

The HMI 8 is arranged in the interior of the motor vehicle 2 so as to be viewable and operable by the driver. The HMI 8 is a user interface or a human-machine interface. It can be a display such as a touch display of the navigation system 10 of the motor vehicle 2, that is additionally designed for voice output of direction of travel instructions.

The navigation system 10 is a technical system that uses position determination (satellite, radio, GSM or inert or autonomous system) and geoinformation (topology maps, road maps, air charts or sea charts) to allow guidance to a chosen destination or a route of travel F bearing in mind desired criteria. The navigation system 10 can resort to stored map data and/or to map data provided in a Cloud.

In the scenario shown in FIG. 1, after the driver has activated the maneuvering assistance system 6, the driver has already covered the stretch of road W having the length L in the motor vehicle 2.

In other words, in the present example, the maneuvering assistance system 6 records surroundings data UD from the time at which it is activated and evaluates them. As a departure from the present exemplary example, there can also be provision for the maneuvering assistance system 6 to record and evaluate surroundings data UD of the stretch of road W having a predetermined length L, such as one kilometer. In other words only data relating to the last few kilometers traveled are recorded and evaluated. This allows the memory requirement to be reduced. The recording and evaluation of the surroundings data UD can be triggered by the driver, or there can also be provision for data relating to the last few kilometers traveled to be recorded and evaluated continually, that is to say independently of activation. As such, surroundings data UD are available immediately upon activation of the maneuvering assistance system 6 and not just after the stretch of road W has been traveled along.

During operation, the maneuvering assistance system 6 reads in the surroundings data UD and the map data record KD and also data representative of the stretch of road W, the length L and the criterion K and the present position P of the motor vehicle 2.

The result of the evaluation of the surroundings data UD is that the first maneuvering space 4a and the second maneuvering space 4b and also the parking space 12 have been detected.

The first maneuvering space 4a and the second maneuvering space 4b can be in the form of a turning facility. The turning facility can be in the form of a turning circle or turning bay and is a rectangular, trapezoidal or round widening at the end of a cul de sac for turning vehicles. In this case, the turning facilities are in a form such that the majority of motor vehicles can turn without reversing. In the present exemplary example, the first maneuvering space 4a and the second maneuvering space 4b are in a form such that reversing is required, however. The first maneuvering space 4a and the second maneuvering space 4b can also be regarded as perpendicular parking spaces, whereas the parking space 12 in the present exemplary example is a parallel parking space, as already mentioned.

The respective positions or position data PD of the respective first maneuvering space 4a and second maneuvering space 4b, and also of the parking space 12, are then added to a map data record KD for the traveled stretch of road W. There is therefore now a map data record KD having position data PD of the respective first maneuvering space 4a and second maneuvering space 4b and of the parking space 12.

The maneuvering assistance system 6 then selects one of the two maneuvering spaces 4a, 4b. To this end, a criterion K is used. The criterion K can be selected from a plurality of criteria by the driver, or can be predetermined. The criteria K selected can be a distance from the respective maneuvering spaces 4a, 4b, and/or their respective size, and/or their suitability or accessibility (e.g., in terms of maneuvering complexity or number of maneuvering moves required or driving over curves). Furthermore, the criterion K can be a distance from a destination, such as a destination stored in a navigation system, or a regularity or frequency with which a destination is headed for by the driver.

In the present exemplary example, the criterion K selected is the distance from the parking space 12. The shortest path to the parking space 12 in the present exemplary example leads via the second maneuvering space 4b, which is reachable by turning the motor vehicle 2 in reverse.

The navigation system 10 then evaluates said data, the position data PD of the selected second maneuvering space 4b and of the parking space 12, to determine a route of travel F starting from the present position P to the parking space 12, which is then visualized on the HMI 8.

It should be noted that the driver has the opportunity to change the selection, i.e., the driver can select the first maneuvering space 4a instead of the second maneuvering space 4b. Consequently, the maneuvering assistance system 6 then determines an alternative route of travel F with the first maneuvering space 4a and the parking space 12 as a destination.

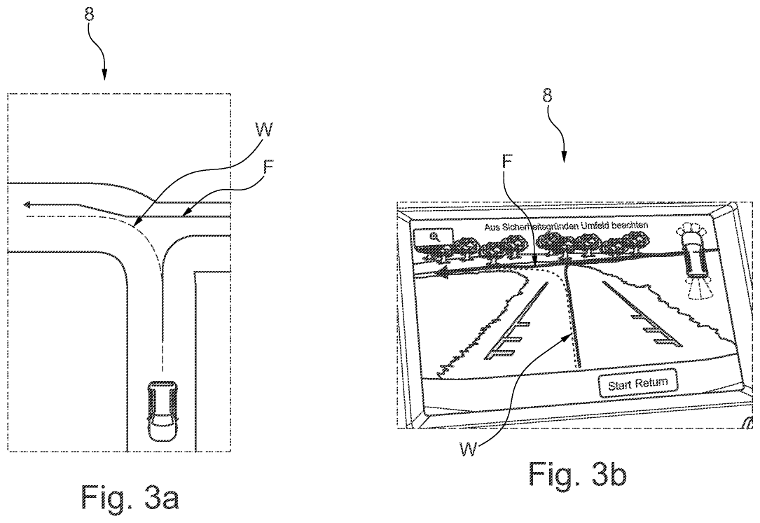

Reference is now additionally made to FIGS. 3a and 3b.

FIG. 3a uses a schematic depiction to show a graphical reproduction of a section of the stretch of road W and the route of travel F on the HMI 8. The depiction in FIG. 3a corresponds to a bird's eye view as in a surround-view system, producing an image of the motor vehicle 2 from above. To this end, image data from a reversing camera and further wide angle cameras on the front and under the two exterior mirrors are digitally combined and presented on the HMI 8.

FIG. 3b, by contrast, uses a schematic depiction to show the image reproduction shown in FIG. 3a in a perspective representation on the HMI 8. In this case, the stretch of road W and the route of travel F are reproduced by a direction arrow inserted into the representation.

Both in FIG. 3a and in FIG. 3b, the route of travel F is depicted in each case by a direction arrow inserted into the representation.

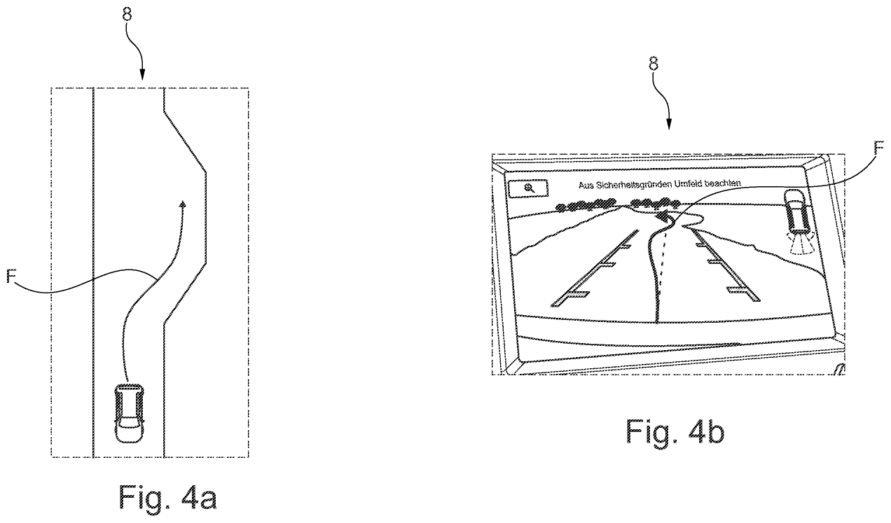

Reference is now additionally made to FIGS. 4a and 4b.

Like FIG. 3a, FIG. 4a uses a schematic depiction to show a graphical reproduction of a maneuvering process on the HMI 8. The depiction in FIG. 4a corresponds to a bird's eye view, provided by the surround view system.

Like FIG. 3b, FIG. 4b also uses a schematic depiction to show the image reproduction shown in FIG. 4a in a perspective representation on the HMI 8. Both in FIG. 3a and in FIG. 4b, the route of travel F is depicted in each case by a direction arrow inserted into the representation.

Therefore, a driver is assisted not only in the parking process itself but also earlier on, i.e., when maneuvering during the search for and selection of a parking space.

### LIST OF REFERENCE SIGNS

2 Motor vehicle
4a Maneuvering space
4b Maneuvering space
6 Maneuvering assistance system
8 HMI
10 Navigation system
12 Parking space
F route of travel
K Criterion
KD Map data record
L Length
P Position
PD Position data
UD Surroundings data
W Stretch of road

1-16. (canceled)

17. A method for operating a motor vehicle, comprising:
receiving surroundings data representing maneuvering spaces along a traveled stretch of road having a predetermined length;
evaluating the surroundings data to determine at least one suitable-for-maneuvering maneuvering space from the maneuvering spaces, and
adding the suitable-for-maneuvering maneuvering space to map data that represents the traveled stretch of road.

18. The method of claim 17, wherein the map data is presented via an HMI in the motor vehicle.

19. The method of claim 17, wherein a route of travel starting from a present position of the motor vehicle is determined by including the suitable-for-maneuvering maneuvering space.

20. The method of claim 19, wherein the route of travel can be modified by a driver of the motor vehicle.

21. The method of claim 17, wherein a plurality of suitable-for-maneuvering maneuvering spaces are determined, and at least one of the plurality of suitable-for-maneuvering maneuvering spaces is selected according to at least one predetermined criterion.

22. The method of claim 17, wherein the map data is reproduced in the form of a 360° panoramic view.

23. The method of claim 17, wherein the map data is reproduced in a perspective representation.

24. A maneuvering assistance system for a motor vehicle, configured to:
receiving surroundings data representing maneuvering spaces along a traveled stretch of road having a predetermined length;
evaluating the surroundings data to determine at least one suitable-for-maneuvering maneuvering space from the maneuvering spaces, and
adding the suitable-for-maneuvering maneuvering space to map data that represents the traveled stretch of road.

25. The system of claim 24, further configured to present the map data via an HMI in the motor vehicle.

26. The system of claim 24, further configured to determine a route of travel starting from a present position of the motor vehicle by including the suitable-for-maneuvering maneuvering space.

27. The system of claim 26, wherein the route of travel can be modified by a driver of the motor vehicle.

28. The system of claim 24, further configured to determine a plurality of suitable-for-maneuvering maneuvering spaces, and to select at least one of the plurality of suitable-for-maneuvering maneuvering spaces according to at least one predetermined criterion.

29. The system of claim 24, further configured to reproduce the map data in the form of a 360° panoramic view.

30. The system of claim 24, further configured to reproduce the map data in a perspective representation.
